(19) United States
(12) Patent Application Publication
(10) Pub. No.: US 2022/0134518 A1
(43) Pub. Date: May 5, 2022

(54) POWER DRIVE ADAPTER TOOL

(71) Applicant: Jeffrey Del Rossa, Pittsburgh, PA (US)

(72) Inventor: Jeffrey Del Rossa, Pittsburgh, PA (US)

(21) Appl. No.: 17/509,393

(22) Filed: Oct. 25, 2021

Related U.S. Application Data
(60) Provisional application No. 63/107,165, filed on Oct. 29, 2020.

(51) Int. Cl. B25B 23/00; B23B 51/12

(52) U.S. Cl. CPC B25B 23/0035; B23B 51/12

(57) ABSTRACT

Embodiments relate to a power drive adapter tool. The tool includes a drive adapter and a drill bit assembly. The drive adapter includes a body having a first end and a second end, the first end having a drive-receiving aperture configured to receive a drive from a drive tool, and the second end having a bit-receiving aperture configured to receive the drill bit assembly. The drill bit assembly has a drill bit and a connector, the connector having a proximal end and a distal end. The drill bit is permanently connected to the distal end, and the proximal end is configured to insert into the bit-receiving aperture.

### CROSS-REFERENCE TO RELATED APPLICATIONS

This application is related to and claims the benefit of priority to U.S. Provisional Application No. 63/107,165, filed on Oct. 29, 2020, the entire contents of which are incorporated herein by reference.

### FIELD OF THE INVENTION

Embodiments relate to a drive adapter configured to secure to a drive tool (e.g., rotary tool, ratchet, drill, etc.) and receive a drill bit having a connector end. The connector end is configured to be removably coupled to the drive adapter so as to permit selective use of different sized drill bits.

### BACKGROUND OF THE INVENTION

Power driven drill systems typically rely on adjustable chuck mechanisms. Adjustable chuck mechanisms are complex and bulky. Adjustable chuck mechanisms require chuck housings that occupy a large volume of space. When attempting to drill into a workpiece in a compromised space (e.g., within an engine), any extra amount of workable space is greatly beneficial. Adjustable chuck mechanisms include gearing and other mechanics that reduce the tolerances with which the power driven system can be used. For instance, the gearing for providing adjustability reduces the ability to hold the drill bit at a perfect angle normal to the workpiece or reduces the ability to ensure that the drill bit is in fact at the intended alignment with respect to the workpiece. Moreover, adjustable chuck mechanisms add to the expense of such systems. Some systems may include the use of adapters, but such adapters do not lend themselves to quick and easy interchangeability of drill bits without the use of complex mechanics within the adapter.

### SUMMARY OF THE INVENTION

Embodiments relate to a drive adapter configured to secure to a drive tool and receive a drill bit having a connector end. The connector end is configured to be removably coupled to the drive adapter so as to permit selective use of different sized drill bits. As noted above, the drive adapter is configured to connect directly to the drive and facilitate interchangeability of drill bits. This allows for the omission of an adjustable chuck mechanism, which can reduce the volume of space being occupied by the drilling apparatus and provide a user with a larger workable area. This is especially beneficial when operating in compromised workspaces. This can also provide the added benefits of ensuring proper alignment of the drill bit and reducing the costs associate with power driven drill systems. While embodiments of the tool are described and illustrated herein as being able to be used without an adjustable chuck mechanism, the tool can be used with an adjustable chuck mechanism. One of the benefits of the tool, however, is obviating the need to do so.

In an exemplary embodiment, a power drive adapter tool includes a drive adapter and a drill bit assembly. The drive adapter includes a body having a first end and a second end. The first end has a drive-receiving aperture configured to receive a drive from a drive tool. The second end has a bit-receiving aperture configured to receive the drill bit assembly. The drill bit assembly has a drill bit and a connector. The connector has a proximal end and a distal end. The drill bit is permanently connected to the distal end. The proximal end is configured to insert into the bit-receiving aperture.

In some embodiments, the proximal end of the connector is threaded and the bit-receiving aperture has complementary threads.

In some embodiments, any one or combination of the proximal end of the connector and an inner surface of the bit-receiving aperture has a locking mechanism comprising a locking-pin, a detent, or a magnet.

In some embodiments, the bit-receiving aperture has a shape that complements a shape of the proximal end of the connector.

In some embodiments, the connector has a collar located at or near the distal end.

In some embodiments, the collar has a circumference that is greater than a circumference of the proximal end.

In some embodiments, the collar has a circumference that is greater than a circumference of the bit-receiving aperture of the drive adapter.

In some embodiments, the collar is a mechanical stop that prevents any further advancement of the connector into the drive adapter when the collar is caused to abut the second end of the drive adapter.

In some embodiments, the collar has any one or combination of a circular shape, a square shape, a hexagonal shape, a smooth surface, and a textured surface.

In an exemplar embodiment, a power adapter tool kit includes a drive adapter and a plurality of drill bit assemblies. The drive adapter has a body having a first end and a second end. The first end has a drive-receiving aperture configured to receive a drive from a drive tool. The second end has a bit-receiving aperture configured to receive any one of the plurality of drill bit assemblies. Each drill bit assembly has a drill bit and a connector. The connector has a proximal end and a distal end. The drill bit is permanently connected to the distal end. The proximal end is configured to insert into the bit-receiving aperture. Each drill bit assembly has a drill bit that differs from a drill bit of another drill bit assembly.

In some embodiments, the drill bit of a drill bit assembly has a drill bit length, a drill bit gauge, and/or a drill bit head that differs from a drill bit length, gauge, and/or bit head of another drill bit assembly.

In an exemplary embodiment, a method of using a drive adapter involves inserting a drive adapter onto a drive of a drive tool. The drive adapter has a body having a first end and a second end. The first end has a drive-receiving aperture configured to receive the drive from the drive tool. The second end has a bit-receiving aperture configured to receive a drill bit assembly. The method involves inserting the drill bit assembly to the drive adapter. The drill bit assembly has a drill bit and a connector. The connector has a proximal end and a distal end. The drill bit is permanently connected to the distal end. The proximal end is configured to insert into the bit-receiving aperture. The method of inserting the drill bit assembly involves inserting the proximal end of the connector into the bit-receiving aperture of the drive adapter.

In some embodiments, the method involves actuating the drive tool to transfer rotary motion to the drill bit.

In some embodiments, the method involves performing work on a workpiece with the rotating drill bit.

In some embodiments, the method involves removing the drill bit assembly from the drive adapter and replacing the drill bit assembly with another drill bit assembly without removing the drive adapter from the drive.

In some embodiments, the drive adapter is connected directly to the drive.

In some embodiments, the drive tool does not have a chuck.

In some embodiments, the proximal end of the connector and the bit-receiving aperture of the drive adapter have complementary threading, and the method involves threading the drill bit assembly to the drive adapter by rotating the drill bit assembly as it is inserted into the bit-receiving aperture.

In some embodiments, the connector includes a collar located at or near the distal end, and the method involves inserting the drill bit assembly into the drive adapter until the collar abuts the second end of the drive adapter.

In some embodiments, the connector includes a collar located at or near the distal end, and the method involves grasping the collar with fingers or a tool to assist with threading the drill bit assembly to the drive adapter.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 is an exploded view of an embodiment of power drive adapter tool with a power drive tool.

FIG. 2 shows an embodiment of the power drive adapter tool, showing the drive adapter juxtaposed with the drill bit assembly.

FIG. 3 shows an embodiment of the drive adapter.

FIG. 4 shows an embodiment of the drill bit assembly.

FIGS. 5-6 show an embodiment of the power drive adapter tool with the drill bit assembly connected to the drive adapter.

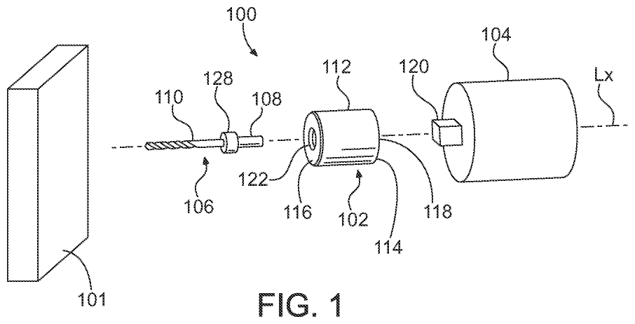

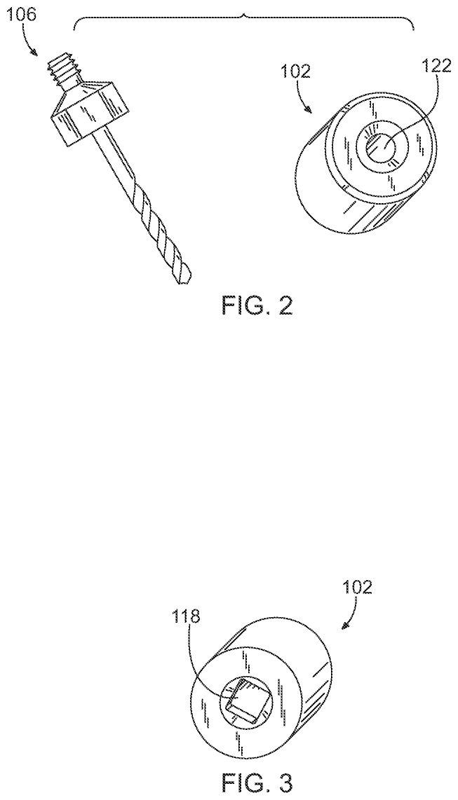

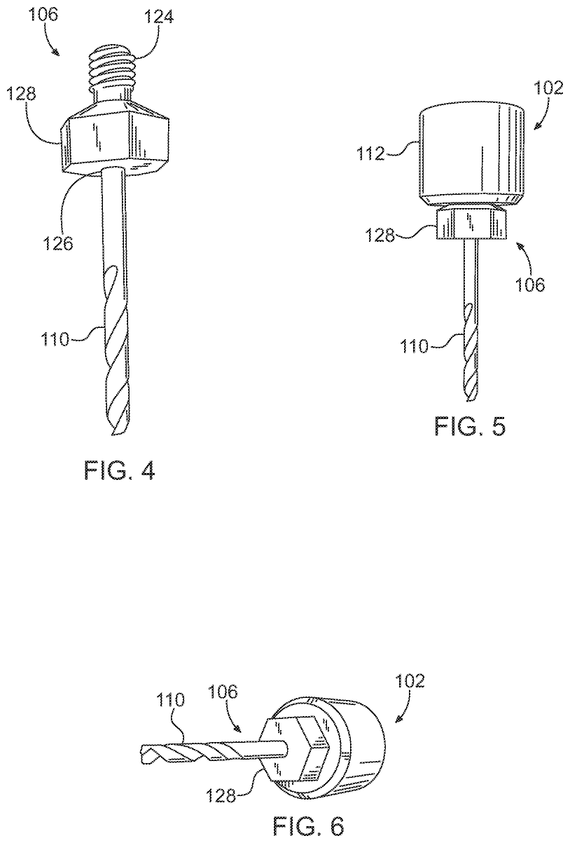

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of various aspects of the present invention. The scope of the present invention is not limited by this description.

Embodiments relate to a power drive adapter tool 100 having a drive adapter 102 configured to secure to a drive tool 104 (e.g., rotary tool, ratchet, drill, etc.) and receive a drill bit assembly 106 having a connector end 108. The connector end 108 is configured to be removably coupled to the drive adapter 102 so as to permit selective use of different sized drill bits 110.

The drive adapter 102 has a body 112 (e.g., metal, ceramic, polyurethane, etc.) with a longitudinal axis Lx running from a first end 114 to a second end 116. It is contemplated for the body 112 to be cylindrical in shape with a circular cross-section when viewed along the longitudinal axis Lx. Other cross-sectional shapes can be used, such a triangular, square, hexagonal, etc. Each of the first end 114 and the second end 116 forms a planar terminus.

The first end 114 has a drive-receiving aperture 118. The drive-receiving aperture 118 is a bore hole formed within the first end 114 planar terminus and is configured to receive a drive 120 of a drive tool 104. The drive tool 104 can be a drill, ratchet, rotary tool, etc. that, when actuated, causes the drive 120 to rotate. The connection between the drive 120 and the drive-receiving aperture 118 causes rotary motion to be transferred to the drive adapter 102 to cause the drive adapter 102 to rotate about the longitudinal axis Lx. The drive 120 of the drive tool 104 is a bar or an extension that is secured to the drive tool 104 (e.g., permanently or temporarily). The drive 120 has a cross-sectional shape, such as a square, hexagon, star-shape, etc. to allow for efficient rotary motion transfer from the drive tool to the drive adapter 102. The drive 120 may have a locking-pin, a detent, a magnet, or other suitable locking mechanism to secure the drive adapter 102 thereto. For instance, the drive 120 can be magnetized, have a magnet attached to a portion thereof, or have an insert that is a magnetic material. When the drive adapter 102 is inserted over the drive 120, the magnetic portion of the drive 120 can attract the drive adapter 102 (the drive adapter 102 in this case being metal), thereby causing the drive adapter 102 to secure to the drive 120 unless force is used to pull the two apart. Similarly, the drive-receiving aperture 118 of the drive adapter 102 may have a locking-pin, a detent, a magnet, or other suitable locking mechanism to secure the drive adapter 102 to the drive 120. For instance, an inner surface of the drive-receiving aperture 118 can be magnetized, have a magnet attached to a portion thereof, or have an insert that is a magnetic material. When the drive adapter 102 is placed over the drive 120, the magnetic portion of the drive adapter 102 can attract the drive 120 (the drive 120 in this case being metal), thereby causing the drive 120 to secure to the drive adapter 102 unless force is used to pull the two apart.

The second end 116 has a bit-receiving aperture 122. The bit-receiving aperture 122 is a bore hole formed within the second end 116 planar terminus and is configured to receive a connector end 108 of a drill bit assembly 106. When the drill bit assembly 106 is connected to the drive adapter 102 (and the drive adapter 102 is connected to the drive tool 104), causing the drive adapter 102 to rotate transfers rotary motion to the drill bit assembly 106 also causing it to rotate. The bore hole of the bit-receiving aperture 122 has a shape that complements the shape of the connector end 108 so that the connector end 108 fits within the bit-receiving aperture 122. It is contemplated for the bit-receiving aperture 122 to be a threaded hole so that a complementary threaded connector end 108 can be threaded thereto for temporary securement of the drill bit assembly 106 to the drive adapter 102. However, any one of the connector end 108 or the bit-receiving aperture 122 can have a locking-pin, a detent, a magnet, or other suitable locking mechanism to secure the connector end 108 to the drive adapter 102. For instance, a similar magnetic securement discussed above between the drive adapter 102 and the drive 120 can also be used between the connector end 108 and the drive adapter 102. Another option is for the bit-receiving aperture 122 to be a hexagonal opening configured to receive a complementary hex head connector end 108.

It is contemplated (especially for a threaded engagement) for each of the connector end 108 and the bit-receiving aperture 122 to have a circular cross-sectional shape, but other shapes can be used (e.g., a triangular, square, hexagonal, etc.).

The drill bit assembly 106 includes a drill bit 110 permanently secured (e.g., via a weld) to a connector end 108. While it is contemplated for the drill bit 110 to be configured for performing work on metal (e.g., drilling into or boring out metal objects), the drill bit 110 can be configured to perform work on other materials. Thus, the drill bit 110 can be configured as a brad point, a flex point, a taper point, a standard point, a split point, a screw point, etc. The drill bit 110 can be made from metal, metal alloy, carbon composite, etc. The drill bit assembly 106 has the drill bit 110 attached to the connector end 108 so that the drill bit 110 and the connector form an elongated assembly having a longitudinal axis Lx. When the drill bit assembly 106 is connected to the drive adapter 102, the longitudinal axis Lx of the drive adapter 102 is coaxial with the longitudinal axis Lx of the drill bit assembly 106.

The connector end 108 is made of metal, ceramic, polyurethane, etc. The connector end 108 has a proximal end 124 and a distal end 126. The drill bit 110 is connected to the distal end 126. The proximal end 124 is configured to secure to the second end 116 of the drive adapter 102. As noted above, the bore hole of the bit-receiving aperture 122 has a shape that complements the shape of the connector end 108 so that the connector end 108 fits within the bit-receiving aperture 122. The complementary shapes are thus between the bit-receiving aperture 122 and the proximal end 124. Again, it is contemplated for the bit-receiving aperture 122 (serving as a female end) to be a threaded hole so that a complementary threaded proximal end 124 (serving as a male end) can be threaded thereto for temporary securement of the drill bit assembly 106 to the drive adapter 102. Again, any one of the proximal end 124 or the bit-receiving aperture 122 can have a locking-pin, a detent, a magnet, or other suitable locking mechanism to secure the connector end 108 to the drive adapter 102. It is also contemplated (especially for a threaded engagement) for each of the proximal end 124 and the bit-receiving aperture 122 to have a circular cross-sectional shape, but other shapes can be used (e.g., a triangular, square, hexagonal, etc.).

The connector end 108 can have a collar 128 formed at or near its distal end 126. The collar 128 can be an annular formation about the circumference of the connector end 108 to facilitate easy rotation of the connector end 108. For instance, if the drill bit assembly 106 is connected to the drive adapter 102 via a threading engagement (e.g., the proximal end 124 and the bit-receiving aperture 122 have complementary threads), then a user can grasp the collar 128 (with their fingers or a tool) to aid in rotating and torqueing the drill bit assembly 106 for proper attachment and detachment to and from the drive adapter 102. The collar 128 can be an annular formation having a circumference that is greater than the circumference of the connector body, or at least a circumference that is greater than the circumference of the proximal end 124. The greater circumference can allow for ease of grasping and manipulation by a user's fingers or by a tool (e.g., wrench) of the user. The collar 128 can have a circular shape, square shape, hexagonal shape, have a smooth surface, have a textured surface, etc.

In an exemplary embodiment, a method for using an embodiment of the drive adapter 102 can include the following steps. A user inserts the drive adapter 102 onto a drive 120 of a drive tool 104 by inserting the drive-receiving aperture 118 over the drive 120. The connection between the drive adapter 102 and the drive 120 can be aided via any of the locking mechanisms discussed herein. A user can select a drill bit assembly 106 having a drill bit 110 that is the length and gauge desired for the work to be performed. The connector end 108 of the drill bit assembly 106 can be connected to the drive adapter 102 by inserting the proximal end 124 of the connector end 108 into the bit-receiving aperture 122 of the drive adapter 102. The insertion can involve threading the connector end 108 to the drive adapter 102 (e.g., the proximal end 124 and the bit-receiving aperture 122 can have complementary threads). A user can use their fingers or a tool (e.g., a wrench) to grasp the collar 128 and torque the connector end 108 (and thus the drill bit assembly 106) so that it is secure to the drive adapter 102. The drive tool 104 can be actuated to cause the drill bit 110 to rotate and perform work on a workpiece 101. A user can remove the drill bit assembly 106 by rotating it so that it advances out from the threaded bit-receiving aperture 122 of the drive adapter 102. A user can then select a different drill bit assembly 106 (e.g., a drill bit 110 with a different length, gauge, bit head, etc.), and insert that drill bit assembly 106 into the drive adapter 102.

In some embodiments, the tool can be used as a kit. For instance, the kit can include a drive adapter 102 and a plurality of drill bit assemblies 106. The drive adapter 102 can include a body having a first end 114 and a second end 116, the first end 114 comprising a drive-receiving aperture 118 configured to receive a drive 120 from a drive tool 104, and the second end 116 comprising a bit-receiving aperture 122 configured to receive any one of the plurality of drill bit assemblies 106. Each drill bit assembly 106 has a drill bit 110 and a connector end 108, the connector end 108 comprising a proximal end 124 and a distal end 126, the drill bit permanently connected to the distal end 126, and the proximal end 124 configured to insert into the bit-receiving aperture 122. Each drill bit assembly 106 has a drill bit 110 that differs from a drill bit 110 of another drill bit assembly 106. For instance, the drill bit 110 of a drill bit assembly 106 can have a drill bit length, drill bit gauge, and/or drill bit head that differs from a drill bit length, gauge, and/or bit head of another drill bit assembly 106.

As can be appreciated from the above disclosure, a single drive adapter 102 can accommodate several different types, styles, and sized drill bit assemblies 106. Each time a different drill bit assembly 106 is secured therein, the drill bit 110 is automatically aligned (e.g., the longitudinal axis Lx of the drill bit 110 is coaxial with that of the drive adapter 102) so as to avoid drill bit 110 wobble, or precession motion, as the drill bit 110 is caused to rotate.

In some embodiments, the collar 128 of the connector end 108 can further serve as a mechanical stop, preventing further insertion of the connector end 108 into the drive adapter 102 (as the circumference of the collar 128 is greater than the circumference of the bit-receiving aperture 122—i.e., the collar 128 abuts against the second end 116 of the drive adapter 102). When the connector end 108 is inserted so that the collar 128 abuts against the second end 116 of the drive adapter 102, the user is assured that the drill bit assembly 106 is properly seated and that the length of the drill bit 110 extending into the workpiece 101 corresponds to an expected length of the drill bit 110. With a chuck mechanism, it is common for the drill bit to not be properly seated, leading to an inaccurate drill bit length. However, the inventive tool allows for use without a chuck mechanism.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. A power drive adapter tool, comprising:
a drive adapter and a drill bit assembly, wherein:
the drive adapter comprises a body having a first end and a second end, the first end comprising a drive-receiving aperture configured to receive a drive from a drive tool, and the second end comprising a bit-receiving aperture configured to receive the drill bit assembly; and
the drill bit assembly comprises a drill bit and a connector, the connector comprising a proximal end and a distal end, the drill bit permanently connected to the distal end, and the proximal end configured to insert into the bit-receiving aperture.

2. The power drive adapter tool of claim 1, wherein the proximal end of the connector is threaded and the bit-receiving aperture has complementary threads.

3. The power drive adapter tool of claim 1, wherein any one or combination of the proximal end of the connector and an inner surface of the bit-receiving aperture has a locking mechanism comprising a locking-pin, a detent, or a magnet.

4. The power drive adapter tool of claim 1, wherein the bit-receiving aperture has a shape that complements a shape of the proximal end of the connector.

5. The power adapter tool of claim 1, wherein the connector comprises a collar located at or near the distal end.

6. The power adapter tool of claim 5, wherein the collar has a circumference that is greater than a circumference of the proximal end.

7. The power adapter tool of claim 5, wherein the collar has a circumference that is greater than a circumference of the bit-receiving aperture of the drive adapter.

8. The power adapter tool of claim 5, wherein the collar is a mechanical stop that prevents any further advancement of the connector into the drive adapter when the collar is caused to abut the second end of the drive adapter.

9. The power adapter tool of claim 5, wherein the collar has any one or combination of a circular shape, a square shape, a hexagonal shape, a smooth surface, and a textured surface.

10. A power adapter tool kit, comprising:
a drive adapter and a plurality of drill bit assemblies, wherein:
the drive adapter comprises a body having a first end and a second end, the first end comprising a drive-receiving aperture configured to receive a drive from a drive tool, and the second end comprising a bit-receiving aperture configured to receive any one of the plurality of drill bit assemblies;
each drill bit assembly comprises a drill bit and a connector, the connector comprising a proximal end and a distal end, the drill bit permanently connected to the distal end, and the proximal end configured to insert into the bit-receiving aperture; and
each drill bit assembly has a drill bit that differs from a drill bit of another drill bit assembly.

11. The kit recited in claim 10, wherein the drill bit of a drill bit assembly has a drill bit length, a drill bit gauge, and/or a drill bit head that differs from a drill bit length, gauge, and/or bit head of another drill bit assembly.

12. A method of using a drive adapter, the method comprising:
inserting a drive adapter onto a drive of a drive tool, wherein:
the drive adapter comprises a body having a first end and a second end, the first end comprising a drive-receiving aperture configured to receive the drive from the drive tool, and the second end comprising a bit-receiving aperture configured to receive a drill bit assembly; and
inserting the drill bit assembly to the drive adapter, wherein:
the drill bit assembly comprises a drill bit and a connector, the connector comprising a proximal end and a distal end, the drill bit permanently connected to the distal end, and the proximal end configured to insert into the bit-receiving aperture; and
inserting the drill bit assembly involves inserting the proximal end of the connector into the bit-receiving aperture of the drive adapter.

13. The method of claim 12, further comprising:
actuating the drive tool to transfer rotary motion to the drill bit.

14. The method of claim 13, further comprising:
performing work on a workpiece with the rotating drill bit.

15. The method of claim 12, further comprising:
removing the drill bit assembly from the drive adapter and replacing the drill bit assembly with another drill bit assembly without removing the drive adapter from the drive.

16. The method of claim 12, wherein the drive adapter is connected directly to the drive.

17. The method of claim 12, wherein the drive tool does not have a chuck.

18. The method of claim 12, wherein the proximal end of the connector and the bit-receiving aperture of the drive adapter have complementary threading, the method further comprising:
threading the drill bit assembly to the drive adapter by rotating the drill bit assembly as it is inserted into the bit-receiving aperture.

19. The method of claim 12, wherein the connector includes a collar located at or near the distal end, the method comprising:
inserting the drill bit assembly into the drive adapter until the collar abuts the second end of the drive adapter.

20. The method of claim 18, wherein the connector includes a collar located at or near the distal end, the method comprising:
grasping the collar with fingers or a tool to assist with threading the drill bit assembly to the drive adapter.
